(19) United States
(12) Patent Application Publication
(10) Pub. No.: US 2024/0375095 A1
(43) Pub. Date: Nov. 14, 2024

(54) PRE-TREATED ION EXCHANGE RESIN FOR ALTERNATIVE ENERGY POWER SOURCE HEAT TRANSFER SYSTEMS WITH LOW CONDUCTIVITY COOLANT REQUIREMENTS

(71) Applicant: CCI North America Corporation, Lemont, IL (US)

(72) Inventors: Timo Martin Weide, Lockport, IL (US); Raul Gonzalez, Chicago, IL (US)

(21) Appl. No.: 18/662,326

(22) Filed: May 13, 2024

Related U.S. Application Data
(60) Provisional application No. 63/465,615, filed on May 11, 2023.

(51) Int. Cl. B01J 47/016; B01J 43/00

(52) U.S. Cl. CPC B01J 47/016; B01J 43/00

(57) ABSTRACT

Methods and apparatus for pre-treated ion exchange resins and their use in heat transfer systems, alternative power sources such as fuel cells, battery systems, and assemblies comprising such power sources. The apparatus may include a cooling system and a pre-treated ion exchange resin. The pre-treated ion exchange resin may include a corrosion inhibitor and/or antioxidant treated ion exchange resin. The cooling system may include a heat transfer fluid. The heat transfer fluid may include water, a glycol-based freeze-point depressant, and mixtures thereof. The glycol-based freeze-point depressant may include ethylene glycol, propylene glycol, 1,3-propanediol, and mixtures thereof. The cooling system may include an ion exchange unit. The ion exchange unit may include a pre-treated ion exchange resin, an untreated ion exchange resin, a basic anion resin, an acidic cation exchange resin, and mixtures thereof.

### CROSS-REFERENCE TO RELATED APPLICATIONS

This application claims the benefit of priority to U.S. Provisional Application Ser. No. 63/465,615, filed May 11, 2023, and entitled PRE-TREATED ION EXCHANGE RESIN FOR ALTERNATIVE ENERGY POWER SOURCE HEAT TRANSFER SYSTEMS WITH LOW CONDUCTIVITY COOLANT REQUIREMENTS, the entire contents of which are incorporated by reference.

### FIELD OF TECHNOLOGY

Aspects of the disclosure relate to pre-treated ion exchange resins. Aspects of the disclosure particularly relate to corrosion inhibitor and/or antioxidant-treated ion exchange resins and their use in heat transfer systems, alternative power sources such as fuel cells, battery systems, and assemblies comprising such power sources.

### BACKGROUND OF THE DISCLOSURE

Heat transfer systems in thermal communication with a power source have been utilized to regulate heat generated during the operation of the power source. For example, automotive vehicles have employed heat transfer fluids and cooling systems that transfer and dissipate heat generated as a by-product of gasoline powered internal combustion engines. In this case, the heat transfer fluids and cooling systems ensure that the engine operates in an optimum environment and is not subject to undesirably high temperatures. Water is present in the heat transfer fluids in an average amount of from 60-100% by weight, based on the total amount of the heat transfer fluid. However, alternatives to traditional gasoline powered internal combustion engines are now desired, especially alternatives that address public concerns regarding the environment and the management of natural resources. As a result, new power source technologies continue to be developed, especially those that provide improvements in energy efficiency. Examples of alternative power sources that have been developed include, but are not limited to, batteries, fuel cells, and solar (or photovoltaic). Such alternative power sources may be used alone or in combinations thereof, such as those employed in hybrid vehicles. Although such alternative power sources often provide improvements in energy efficiency as compared to gasoline powered internal combustion engines, they continue to require the use of heat transfer systems and heat transfer fluids. In particular, heat transfer systems and fluids are necessary to maintain optimum operating conditions, particularly in regard to temperature.

Unfortunately, however, traditional prior art cooling systems and heat transfer fluids may be unsuitable for use with alternative power sources, especially those employing electricity or an electrical charge. For example, traditional prior art heat transfer fluids are typically characterized by extremely high electrical conductivities, often in the range of 3000 μS/cm or more. The use of highly conductive heat transfer fluids with alternative power sources, especially electricity-based alternative power sources, can result in electrical shock, hydrogen evolution after battery pack damage, increased corrosion and/or the short circuiting of electrical current. As a result, conventional heat transfer fluids may be undesirable for use with alternative power sources, especially with electricity-based alternative power sources.

Fuel cells and battery electric vehicles (“BEVs”) are a particularly attractive alternative power source because of their clean and efficient operation. The electrochemical reactions that occur at fuel cell or battery electrodes are exothermic, i.e., they produce heat. It is therefore necessary to control the exothermic heat produced during the electrochemical reactions. For example, to achieve optimal operating conditions, the normal operating temperature of a Proton Exchange Membrane or Polymer Electrolyte Membrane (“PEM”) fuel cell assembly is controlled so that it remains within a range of from 60° C. to 95° C. To achieve optimal operating conditions during charging and discharging of a battery system, the temperature should remain within a range of from 20° C. to 40° C.

Because of the exothermic nature of the electrochemical reactions, it is desirable to use a heat transfer fluid to keep the electrode assembly at an operating temperature that is within the desired operating temperature range. However, the presence of an electrical charge makes it challenging to use fuel cells with prior art heat transfer systems and fluids. Moreover, to produce sufficient power, a fuel cell-based automotive engine might have many fuel cells connected in series to form a fuel cell stack. Individual fuel cells may have an operating voltage of from 0.6 to 1.0 V DC. In one instance, it is contemplated that anywhere from 100 to 600 individual fuel cells might be connected in series. As a result, the DC electrical voltage across automotive fuel cell stacks could be high, typically ranging from 125 to 450 V DC. The same principle also applies to battery systems. These same voltages are experienced in the heat transfer fluid systems of the individual fuel cells used in automotive fuel cell stacks or if a battery pack breaks. To prevent or minimize electrical shock hazard, it may be desirable that heat transfer fluid have low conductivity. Low electrical conductivity for fuel cell heat transfer fluid may also be desirable for the reduction of shunt current in the heat transfer fluid system and the minimization of system efficiency reduction. It may therefore be desirable to provide low conductivity heat transfer fluids intended for use in heat transfer systems that are in thermal communication with alternative power sources. For BEVs, it is important to ensure that there is no fire or hydrogen evolution when the coolant comes in direct contact with the battery system. This is best achieved with coolants with low electrical conductivity, specifically below 100 to 300 μS/cm. Several international standards have been addressing low conductivity coolants for BEV applications, e.g., GB 29743.2 and ASTM. Various methods for maintaining low electrical conductivity in a heat transfer fluid have been proposed.

It may be desirable that fuel cells and/or batteries for mobile use, particularly in motor vehicles, be capable of operating at low exterior temperatures of down to about −40° C. A freeze-protected coolant circuit may therefore be desirable and freeze-point depressants may be added to the heat transfer fluid. Illustrative examples of particularly suitable freeze-point depressants may include ethylene glycol, propylene glycol, and 1,3-propanediol. Freeze-point depressing alcohols may be present in the heat transfer fluids in an average amount of from 30-60% by weight, based on the total amount of the heat transfer fluid. Such a freeze-point depressant may become oxidized during use thereby producing ionic substances like glycolic and lactic acid. Further, the rate of decomposition may increase with temperature and in the presence of transition metals, e.g., some stainless-steel components may accelerate glycol decomposition but may not themselves corrode. Further, cooling subsystems are typically closed (sealed) when operating at temperatures above about 60° C. so that the coolant may not be freely exposed to air in order to avoid rapid oxidation of the glycol. Such ionic oxidation by-products may raise electrical conductivity of the coolant, which could result in the “short circuiting” of the power source. The presence of these oxidation by-products can also significantly accelerate corrosion in a coolant circulation loop. Ionic substances can also stem from impurities during manufacture or from materials used during assembling of the heat transfer system, e.g., flux residue from radiator brazing. Therefore, aluminum and plastic components might be used but they must be screened in order to determine whether they either accelerate glycol decomposition or whether they corrode to produce soluble ionic impurities in the pure coolant. The coolant paths of a fuel cell system are therefore generally provided with an ion-exchanger or an ion exchange resin to remove any such ionic substances. The capacity of the ion exchanger deteriorates as time goes by because the ion exchanger is “consumed” in the removal of the ionic substances. Periodically, the coolant and ion-exchange resin need to be replaced to prevent potential corrosion and glycol degradation products accumulation, which could result in increased conductivity and potential system failure. Ion-exchange resins are composed of organic material and are therefore prone to decomposition. While cation exchange resins have a maximum operating range up to 120° C., anionic exchange resins in their hydroxide-form are often only recommended to be used below 60° C. For some applications, 60° C. is below the optimum operating temperature.

It may be desirable for a heat transfer fluid to have corrosion resistance. Heat transfer systems often have several metallic components. Illustrative metals found in fuel cell and battery cooling systems and other heat transfer systems include ferrous and non-ferrous alloys such as stainless steel, aluminum, brass, braze alloy, and the like. Also, the use of dissimilar metals in the coolant loop may lead to galvanic corrosion and this is to be avoided where possible. However, such metals are vulnerable to corrosion because of contact with the heat transfer fluid. It may be desirable, therefore, to provide corrosion-inhibiting heat transfer fluids that minimize corrosion of metallic heat transfer system components and prolong the service life of fuel cell and battery cooling systems and other heat transfer systems. However, many of the corrosion inhibitors previously known for use in internal combustion engine coolants may be undesirable for use in fuel cell heat transfer fluids because they are typically highly conductive ionic species. Illustrative examples of such corrosion inhibitors are inorganic silicates, nitrites, molybdates, nitrates, carboxylates, phosphates, borates, and the like. Ion exchange resins may remove ionic corrosion inhibitors. As a result, the fuel cell heat transfer fluid may lose its ability to inhibit the corrosion of metal components of the fuel cell heat transfer system. More particularly, there remains a need for low conductivity heat transfer fluids that also inhibit corrosion of heat transfer systems in thermal communication with alternative power sources. Current state of the art inhibitors in low conductivity coolant are triazole-based and/or contain organic silicate derivatives. Alkyl, hydroxyalkyl, and aromatic amines, or mixtures thereof, can also be used as corrosion inhibitors in coolants with limited conductivity.

Accordingly, there have been several prior art attempts to solve these current coolant challenges.

US 2003/0198847 A1 describes fuel cell coolants comprising alcohols and polyalkylene oxides.

WO 2000/017951 describes a cooling system for fuel cells, in which a pure ethylene glycol/water mixture in a ratio of 1:1 without additives is used as coolant. To provide corrosion protection for materials present in the cooling system, the cooling circuit includes an ion-exchange unit to maintain the purity of the coolant and ensure a low specific conductivity over a prolonged time, thereby preventing short circuits and corrosion. As suitable ion exchangers, mention is made of anionic resins such as those of the strongly alkaline hydroxyl type and cationic resins such as those based on sulfonic acid groups as well as other filtration materials such as activated carbon.

WO 02/101848 A2 describes antifreeze compositions for cooling systems in fuel cell drives and concentrates thereof, which include specific azole derivatives.

DE 10063951 A1 describes coolants for cooling systems in fuel cell drives, which include ortho-silicic esters as corrosion inhibitors.

WO 2018/095759 relates to coolants for cooling systems in electric vehicles having fuel cells and/or batteries based on alkylene glycols or derivatives thereof, which include additional corrosion inhibitors for improved corrosion protection in addition to specific azole derivatives.

U.S. Pat. No. 8,951,689 describes a fuel cell system with a coolant containing an additive package. The ion exchange resin is prepared so that adsorption of the additive on the ion exchange resin is in a saturated state.

U.S. Pat. No. 9,587,154 discloses a pre-treated ion exchange resin where at least 15% of exchangeable groups, based on the total number of exchangeable groups, were exchanged by at least one of an ion, a Lewis acid, or a Lewis base resulting from a heat transfer fluid component. The heat transfer fluid contains a corrosion inhibitor.

U.S. Pat. No. 7,344,655 describes a fuel cell coolant containing a solution mixture of water and glycol as base material, a rust-preventive additive that functions to keep an electric conductivity of the coolant at a low level. The rust-preventive agent includes at least one of an alkaline ethanolamine additive, and an acidic additive selected among a group consisting of triazole compounds, phosphoric acid compounds, and organo-phosphoric acid compounds

U.S. Pat. No. 7,138,199 is directed to a coolant composition with additives useful in fuel cells. The base composition is de-ionized water or a mixture of de-ionized water and a freezing point depressant. The additive package contains an organic corrosion inhibitor and a polymeric ion suppressant.

### SUMMARY OF THE DISCLOSURE

Disclosed are, inter alia, a pre-treated ion exchange resin, methods of maintaining low conductivity in a heat transfer fluid, and methods of making a pre-treated ion exchange resin. The pre-treated ion exchange resin may include up to 100% by total number of exchangeable groups comprising at least one of an ion, a Bronsted acid, or a Bronsted base, resulting from treatment with a resin treatment fluid component, having a pKa of 0 to 14 in an aqueous solution at 25° C., based on the total number of exchangeable groups. For performance requirements, different treated or untreated resins can be mixed and combined.

In some embodiments suitable resin treatment components may have a pKa of 0 to 14 in an aqueous solution at 25° C. In one embodiment, the resin treatment component may be a corrosion inhibitor and/or reducing agent. The anti-corrosive/reducing additive is such a reagent as suppressing oxidation of the heat transfer fluid to prevent electrical conductivity of the coolant composition from increasing or such a reagent as blocking ions eluting into a cooling system to prevent electrical conductivity of the coolant composition from increasing. In some specific embodiments, the reducing agent may also be a corrosion inhibitor specific for ferrous metals and aluminum when released from the resin.

Also disclosed is a method of making a treated ion exchange resin, comprising contacting anion and/or cation exchange resin with an aqueous treatment solution comprising a resin treatment component having a pKa of 0 to 14 in an aqueous solution at 25° C. for a period sufficient to exchange up to 100% of the exchangeable sites with the resin treatment component. Also disclosed is a method of making an anionic ion exchange resin more resistant to high temperatures.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows illustrative chemical structures in accordance with the principles of the disclosure;

FIG. 2 shows an illustrative chemical reaction in accordance with the principles of the disclosure;

FIG. 3 shows a photograph comparison of substances treated with and without an ion exchange resin used in accordance with the principles of the disclosure;

FIG. 4 shows a photograph of coupons of metal used in accordance with the principles of the disclosure;

FIG. 5 shows a photograph of a comparison of substances treated with and without an ion exchange resin used in accordance with the principles of the disclosure;

FIG. 6 shows an illustrative schematic diagram in accordance with the principles of the disclosure; and

FIG. 7 shows an illustrative table containing results in accordance with the principles of the disclosure.

### DETAILED DESCRIPTION OF THE DISCLOSURE

Apparatus, methods, and compositions are disclosed. The compositions may include resins.

The terms “heat transfer fluid” or “coolant,” as used herein, refer to a fluid that is capable of transferring and dissipating a quantity of thermal energy from a first point to a second point. In some embodiments, the disclosed heat transfer fluids may also be referred to as antifreeze, due to the ability of some heat transfer fluids to function as freezing point depressants. The term “resin treatment fluid component” as used herein refers to a reagent in an aqueous solution that is used to treat, more specifically pre-charge or pre-treat, the ion exchange resin with corrosion inhibitors and/or a reagent with reducing properties. Herein, reference water-glycol-based low conductivity heat transfer fluids may be used, which can contain inhibitors and/or corrosive salts commonly present when non-demineralized water is used for heat transfer fluid preparation. Further, other means for maintaining a necessary purity of the coolant may be employed even when non-deionized water is used, or heat transfer systems are not specifically cleaned before use. For instance, means for suitably reducing a rate of decomposition may be used and combined with means for removing ionic impurities. The described alternative involves scavenging oxygen in a circulating coolant thereby retarding a decomposition rate, e.g., by using a de-oxidizing resin such that it removes dissolved oxygen, or it reduces ionic species. Further, a means for maintaining a necessary purity and corrosion-inhibiting properties may be employed by a pre-charged resin with de-oxidizing properties, which can also release a corrosion inhibitor. From a user perspective, this approach can possibly allow the usage of non-deionized water or less extensive system cleaning procedures for specific BEV and/or electric system applications.

The term “low conductivity” as used herein generally refers to electrical conductivities of no more than 200 μS/cm. In some embodiments, suitable heat transfer fluids may have a conductivity of less than 150 μS/cm, while in some embodiments, the suitable heat transfer fluids may have a conductivity of less than 50 μS/cm. In other embodiments, suitable heat transfer fluids may have an electrical conductivity of from 0.02 μS/cm to no more than 200 μS/cm. In some embodiments, the disclosed heat transfer fluids for use in fuel cells may have a conductivity of from 0.2 μS/cm to 100 μS/cm. In some embodiments, the disclosed heat transfer fluids may have a conductivity of from 0.05 to less than 50 μS/cm, while in some embodiments, the disclosed heat transfer fluids may have a conductivity of from 0.05 to no more than 25 μS/cm. In some embodiments, the disclosed heat transfer fluids may have an electrical conductivity from 0.05 to no more than 10 μS/cm. In some embodiments, the disclosed heat transfer fluids may have an electrical conductivity from 0.05 to no more than 5 μS/cm. The electrical conductivity of the disclosed heat transfer fluids may be measured by using the test methods described in ASTM D1125, i.e., “Standard Test Methods for Electrical Conductivity and Resistivity of Water” or an equivalent method.

In some embodiments, the resin treatment component present in the pre-treated resin may be a corrosion inhibitor and/or reducing agent. In some embodiments, a pre-treated ion exchange resin such as a corrosion inhibitor and/or reducing agent treated ion exchange resin results from the pretreatment of ion exchange resins with one or more resin treatment components as described above. In some embodiments, the resin treatment component may be a corrosion inhibitor and/or reducing agent. In some embodiments, the disclosed corrosion inhibitor and/or reducing agent treated ion exchange resins may be made by contacting an ion exchange resin with an aqueous resin treatment fluid containing one or more treatment components such as corrosion inhibitors and/or reducing agents. More specifically, a preparation device may include a supply container to supply a solution containing the predetermined corrosion inhibitor and/or reducing reagent, a column or a solution channel, which contains the ion exchange resin, a pump, and a recovery container. A flow meter can be used to control pressure and absorption rate. It is recommended to use inert materials. The solution is made to pass through the ion exchange resin until the additives are no longer absorbed. The treatment results in the exchange of the treatment component such as an inhibitor and/or reducing agent with the exchangeable groups on the ion exchangeable resin. The resultant pre-treated ion exchange resins, and in some embodiments, the corrosion inhibitor and/or reducing agent treated ion exchange resins, may be cleansed with de-ionized water.

Illustrative examples of suitable ion exchange resins may include anion exchange resins, cation exchange resins, mixed bed ion exchange resins, and mixtures thereof. The ion exchange resin selected is dependent upon the type of heat transfer fluid component used in the heat transfer fluid. Although a corrosion inhibitor and/or a reducing agent is used in the discussion below, it will be appreciated that it is merely illustrative of one type of heat transfer fluid component suitable for use in making and obtaining a treated ion exchange resin. The ion exchange resins suitable for use in making any of the pre-treated ion exchange resins disclosed herein may generally have a polymer matrix and functional groups paired with an exchangeable ion form. The exchangeable ion form is generally one or more of Na⁺, H⁺, OH⁻, or Cl⁻ ions, depending on the type of ion exchangeable resin. These exchangeable ions exchange with the ionic species produced by the one or more corrosion inhibitors and/or reducing agents present in an aqueous corrosion inhibitor treatment solution. These exchangeable ions exchange with any ionic species produced by the one or more corrosion inhibitors and/or reducing agents present in an aqueous inhibitor treatment solution and in some cases with the ionic inhibitor species present in a corrosion-inhibiting heat transfer fluid.

For example, if a heat transfer fluid component such as a corrosion inhibitor and/or a reducing agent becomes a negatively charged species in solution, the ion exchange resin should be a mixed bed resin, an anion exchange resin, or a mixture thereof. Commercially available anion exchange resins are typically in either OH⁻ or Cl⁻ forms. In some embodiments, a selected anion exchange resin may be in the OH⁻ form. Alternatively, if a heat transfer fluid component such as a corrosion inhibitor and/or reducing agent in a corrosion-inhibiting heat transfer fluid becomes a positively charged species in solution, then mixed bed resins, cation exchange resins or a mixture thereof should be used. Commercially available cation exchange resins are typically in either H⁺ or Na⁺ forms. In some embodiments, a selected cation exchange resin may be in the H⁺ form. In some embodiments, ion exchange resins in Na⁺ or Cl⁻ forms may be used only if the treatment with an aqueous component solution such as an aqueous corrosion inhibitor and/or reducing agent solution results in the removal of substantially all the Na⁺ or Cl⁻ ions from the ion exchange resin. For example, in some embodiments, ion exchange resins in Na⁺ or Cl⁻ forms may be used only if the treatment with the aqueous component solution results in the production of a corrosion inhibitor treated ion exchange resin having at least 95% of exchangeable groups comprising a suitable corrosion inhibitor and/or reducing agent. Examples of illustrative polymer matrices may include polystyrene, polystyrene, and styrene copolymers, polyacrylate, aromatic substituted vinyl copolymers, polymethacrylate, phenol-formaldehyde, polyalkylamine, combinations thereof, and the like. In some embodiments, the polymer matrix may be polystyrene and styrene copolymers, polyacrylate, or polymethacrylate, while in some embodiments, the polymer matrix may be styrene divinylbenzene copolymers. Examples of illustrative functional groups in cation ion exchange resins may include sulfonic acid groups (—SO₃H₂), and carboxylic acid groups (e.g., —COOH, —(CH)═(CH)—COOH, etc.), combinations thereof, and the like. Examples of illustrative functional groups in anion exchange resins may include quaternary ammonium groups, e.g., benzyltrimethylammonium groups (also termed type I resins), benzyldimethylethanolammonium groups (also termed type II resins), trialkylbenzyl ammonium groups (also termed type I resins), or tertiary amine functional groups, and the like. In some embodiments, the functional groups in an anion exchange resin may be trialkylbenzyl ammonium, trimethylbenzyl ammonium, or dimethyl-2-hydroxyethyl benzyl ammonium, while in some embodiments, the functional groups in an anion exchange resin may be trialkylbenzyl ammonium.

Ion exchange resins can be classified into 4 different groups: strong basic anion (“SBA”), weak basic anion (“WBA”), strong acidic cation (“SAC”), and weak acidic cation (“WAC”) ion exchange resins. While strong basic anion and strong acidic cation ion exchange resins bind their ionic counterpart ions in solution strongly via ionic interactions, weak acidic cation and weak basic anion resins are usually in an equilibrium with weak basic ions and, respectively, with weak acidic ions, Bronsted bases, and Bronsted acids, in solution. The equilibrium constant K depends on the pKa and pKb values of the functional groups bound to the resin matrix and the pKa and pKb values of the ionic species in solution. pKa and pKb are connected through the following equation:

$$pKa + pKb = 14$$

When a reversable ion exchange interaction with the ion exchangeable groups bound onto the resin is desired, weak acidic cation, e.g., a resin with carboxylic acid (—COOH), and/or weak basic anion, e.g., a resin with tertiary amine (—NR₃), ion exchange resins may be used in combination with a weak Bronsted acid or Bronsted base present in solution. For example, if a low concentration of an inhibitor containing a carboxylic acid functional group is required over time in a heat transfer fluid, a weak basic anion resin with a tertiary amine group should be used. In this case, both the pKb and pKa of the functional groups bound to the resin and the inhibitor in solution are similar, which may allow an inhibitor equilibrium in solution. For complete ion removal from a heat transfer fluid onto the SAC resin, e.g., a resin with sulfonic groups (—SO₃H₂) in H-form, and SBA resin, e.g., a resin with benzyltrimethylammonium groups in OH-form, ion exchange resins should be used.

A representative fuel cell coolant was used, which contains triazoles and a stabilized, non-ionic organic silicate derivative. Strong acidic cation and strong basic anion resins in original H- and OH-forms were used with different cation/anion ratios. To simulate glycol oxidation conditions during operating conditions, experiments were repeated with a certain amount of glycolic acid (20 mg) added to the representative fuel cell coolant. The total amount of resin was left constant.

For our applications, specifically fuel cells and BEV, strong mixed bed ion exchange resins may be used to allow low electrical conductivity over time. As some common corrosion inhibitors in low conductivity coolants, like benzotriazoles and silicate, have low pKa values, a careful selection of the resin type and ratio between anionic and cationic ion exchange resin can prevent inhibitor filtration and maintain corrosion performance. With a pKa of 8.2, benzotriazole shows weak acidic properties. Silicic acid, Si(OH)₄, is even weaker than benzotriazole, based on silicic acid's pKa₁ of 9.51. Both substances can bind to a strong anionic exchange resin in its hydroxide form. Due to silicic acid's weaker acidity, benzotriazole may bind when both substances are offered in the same concentration and the resin amount does not exhaust the inhibitor amount. When other ions are offered like glycolic acid, which stems from glycol oxidation, the ion with the stronger acidity, i.e., smaller pKa, may replace the benzotriazole and/or silicic acid, the resin may release the resin-bound corrosion inhibitors, and the resin may function as a quasi-slow releasing inhibitor “depot.”

The resin binding properties do not only depend on the pKa or pKb of the inhibitors in solution. SBA type II resin is less basic than SBA type I resin due to its hydroxyethyl-substitution on the quaternary nitrogen. This property causes benzotriazoles or silicic acid to bind weakly or not at all to the resin and allows corrosion inhibitors to stay in solution. Although not specifically illustrated here, strong acidic substances with a low pKa value, and/or multivalent ions (Fe³⁺, Al³⁺) bind strongly and irreversibly to strong anionic or strong acidic resin.

In a low conductivity heat transfer environment, the ion exchange resin functions as a reserve alkalinity buffer. To allow system operation in the proper pH-range of 5.5 to 8.0, mixed bed resins with a higher anion exchange resin ratio should be chosen to allow a slightly basic or neutral environment. When fuel cell or BEV heat transfer fluids with benzotriazole and/or silicic acid derivatives as corrosion inhibitors are used, it is recommended to use a type II strong anionic resin in its hydroxide form over type I. Different applications, in particular different heat transfer fluid technologies distinguished by corrosion inhibitor selection may therefore require different mixed-bed ion exchange resins or resin ratios for system and performance optimization. The results show that heat transfer fluids containing triazole and silicic acid derivatives may achieve their best corrosion performance with type II strong basic anionic mixed bed resins, as the corrosion inhibitors are less likely to be filtered out by the resin. This finding is especially pronounced for the less acidic silicic acid. To ensure optimal corrosion performance, a mixed-bed resin with a slightly higher anion/cation ratio than 1:1 mol equivalent may allow a minimum initial triazole concentration for yellow metal corrosion protection. Each original low conductivity heat transfer fluid contained 500 ppm of benzotriazole (“BTZ”) and 500 ppm of tolyltriazole (“TTZ”). The original Si-content was 100 ppm, as measured by inductively coupled plasma optical emission spectroscopy (“ICP-OES”).

TABLE 1

| | | | Conductivity | Si | BTZ | TTZ |
|---|---|---|---|---|---|---|
| SAMPLE | RESIN | pH | (μS/cm) | (mg/L) | (mg/L) | (mg/L) |
| 1 | 1 g SAC | 4.32 | 4.744 | 90 | 400 | 300 |
| 1* | 1 g SAC | 3.37 | 32.45 | 100 | 400 | 300 |
| 2 | 1 g Mixed-bed | 7.1 | 0.209 | 40 | 3 | 4 |
| 2* | 1 g Mixed-bed | 5.12 | 0.641 | 60 | 80 | 90 |
| 3 | 0.33 g SAC | 6.14 | 0.132 | 25 | 0 | 0 |
| | 0.67 g SBA (Type I) | | | | | |
| 3* | 0.33 g SAC | 5.95 | 0.250 | 35 | 8 | 11 |
| | 0.67 g SBA (Type I) | | | | | |
| 4 | 1 g SBA Type I | 6.6 | 0.255 | 20 | 0 | 0 |
| 4* | 1 g SBA Type I | 6.55 | 0.240 | 20 | 0 | 0 |
| 5 | 1 g SBA Type II (OH-Form) | 8.40 | 0.945 | 85 | 0 | 0 |
| 5* | 1 g SBA Type II (OH-Form) | 7.93 | 0.685 | 90 | 0 | 0 |

*20 mg glycolic acid added
100 mL fuel cell coolant at room temperature for 5 days

The ion exchange resin may be contacted with an aqueous treatment solution comprising a suitable resin treatment fluid component such as a corrosion inhibitor and/or reducing agent. It will be appreciated that other components such as described herein may also be suitable for use. Suitable resin treatment components that may be used to make the pre-treated resin may include all components that form either an ionic species or act as a Bronsted acid or a Bronsted base in an aqueous solution at 25° C. In some embodiments, suitable resin treatment fluid components may have a pKa from 2 to 12 in an aqueous solution at 25° C. In some embodiments, suitable resin treatment fluid components may have a pKa from 2 to less than 12 in an aqueous solution at 25° C. One example of a suitable resin treatment fluid component is a treatment corrosion inhibitor and/or reducing agent. Suitable treatment inhibitors and/or reducing agents for use in the aqueous treatment solution of an inhibitor may include weakly ionic corrosion inhibitors that are soluble or dispersible in an alcohol or in a mixture of one or more alcohols and water, or only water. Corrosion inhibitors suitable for use as treatment inhibitors, in some embodiments, may have pKa values of equal to or greater than 2, if they are Bronsted acids in aqueous solution at 25° C. In some embodiments, suitable treatment inhibitors may have pKa values from 2 to 12. In some embodiments, suitable acidic treatment inhibitors may have pKa values from 2 to less than 12. If a treatment inhibitor is a Bronsted base, the pKb value of suitable treatment inhibitors should be equal to or greater than 5 in an aqueous solution at 25° C. In some embodiments, suitable Bronsted basic treatment inhibitors may have pKb values from 5 to 12. In some embodiment, a suitable Bronsted basic treatment inhibitor may have a pKb value from 5 to less than 12. In some embodiments, suitable treatment inhibitors may possess good stability in a mixture of alcohol and water under system operating conditions, i.e., typically temperatures of from about 40° C. to about 100° C. In some embodiments, a treatment component such as a treatment inhibitor may include at least some minimum number of functional groups that may form an ionic species due to hydrolysis in an aqueous alcohol or alkylene glycol solution. In some embodiments, the treatment inhibitor may include from 1 to 10 number of ionic forming functional groups per molecule of treatment inhibitor. In some embodiments, the treatment inhibitor may include from 1 to 5 number of ionic forming functional groups per molecule of treatment inhibitor. Illustrative ionic forming functional groups may be those selected from a group consisting of amine groups, heterocyclic aromatic groups, other N-containing groups, carboxylic acid groups, phosphoric acid groups, phosphorous acid groups, hypophosphorous acid groups, and sulfurous acid groups, or sodium and potassium salts thereof.

The aqueous inhibitor solution used to make the corrosion inhibitor and/or reducing agent treated ion exchange resins may generally have a concentration of treatment inhibitor as described above of at least 10000 ppm. In some embodiments, the aqueous inhibitor solution may have a concentration of from 1% to 90% by weight, while in some embodiments, the aqueous inhibitor solution may have a concentration of from 2% to 10% by weight. In some embodiments, the aqueous inhibitor solutions may be made with de-ionized water.

The pre-treated ion exchange resin may contain a treatment inhibitor. The treatment inhibitor may include a phosphorous compound with reducing properties. The phosphorous compound may include a phosphorous acid, hypophosphorous acid, or organophosphorus compounds, like phosphonic acid esters, containing H—PO(OH)ₘ(OR)ₘ structures where R may be an alkyl, hydroxyalkyl, or aryl-group, n and m may be 0-2, and n+m may be 2. Phosphonic acid and its esters may also function as antioxidants bound to a pre-treated resin and may slow down glycol degradation. Mono- or disodium or mono- or dipotassium salts of the corresponding acids may also be used as resin treatment components. Phosphorous compounds usually bind strongly to an SBA ion exchange resin. Nevertheless, phosphorous compounds may be released from a pre-treated resin by stronger binding corrosive ions, like sulfates or carbonates. When corrosive water, which contains chloride, is used as a heat transfer fluid, an untreated mixed-bed ion exchange resin may be included to bind chloride selectively.

In some embodiments, the treatment inhibitor may include an amine. Specifically, hydrazine derivatives of the general formula R₂N—NR₂, or carbohydrazide derivatives of the general formula (R₂N—NH)C═O(HN—NR₂) may be used, where R may be either —H, a C1-C6 alkyl, or alkenyl. All derivatives may be symmetrically or unsymmetrically substituted. R═—H may be an embodiment. When hydrazine derivatives react with oxygen, nitrogen and water may be released as oxidized by-products. Hydrazine oxidation with oxygen therefore may create its own inert atmosphere avoiding oxidation of glycol. In some cases, it is recommended to use a catalyst to enable de-oxidizing reactions at ambient temperature.

Hydrazine and its derivatives have basic properties, and therefore, bind to strong acidic cation resins in H-form. When hydrazine derivatives bound to a resin react with oxygen, nitrogen may be released, and the resin may be returned to its original state. It is therefore feasible to frequently inject small amounts of a hydrazine solution into a resin filter container according to oxygen scavenging demands and operating conditions. The term “operating conditions” may be considered when a pre-treated ion exchange resin contacts a coolant.

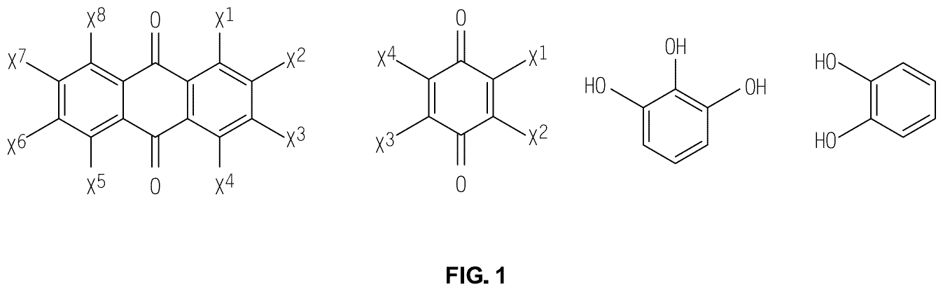

Anthraquinone derivatives are known for their catalytic reduction/oxidation (“RedOx”) properties and play an important role in chemical synthesis and energy storage, e.g., the anthraquinone process for hydrogen peroxide production, the Soda QA process in the paper industry, in anthraquinone flow batteries, as described in WO 2015/048550 and EP 4106060, and in Fieser's solution, an aqueous solution of potassium hydroxide, sodium hydrosulfite, and sodium anthraquinone β-sulfonate used for the removal of oxygen from a gas stream. Anthraquinone derivatives function as catalysts. Anthraquinone may be reduced to an anthrahydroquinone derivative by the reducing agent bond to the resin. Subsequently, the anthrahydroquinone may reduce ionic species back to alcohols and prevent electric conductivity from increasing. Or anthrahydroquinone can simply reduce oxygen to water and prevent corrosion from occurring. The anthraquinone or benzoquinone does not necessarily need to be charged but should be soluble in the heat transfer media. The catalyst derivatives may have the following structures (FIG. 1):

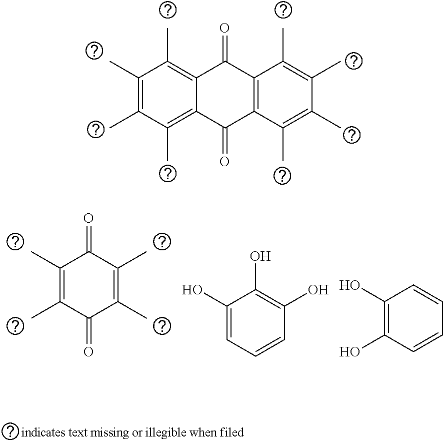

wherein: X¹, X², X³, X⁴, X³, X⁶, X⁷, and X⁸ may be independently selected from a group consisting of a hydrogen atom, a halogen atom, an ether group of the general formula-OR, a linear, cyclic or branched, saturated or unsaturated, optionally substituted, hydrocarbon group comprising from 1 to 10 carbon atoms, a —OH group, a —NR₂ group, a —SO₃H group, or a —COOH carboxylic acid group, or salts thereof. R may represent a linear, cyclic, or branched, saturated, or unsaturated, optionally substituted, hydrocarbon group comprising from 1 to 10 carbon atoms. R may also represent a hydrogen radical. Pyrogallol and Catechol may also be used as catalysts.

A pre-treated ion exchange resin for inhibiting corrosion is provided. The pre-treated ion exchange resin may include a component. The component may be configured to undergo a change in oxidation state when the resin contacts a heat transfer fluid. The component may be an acidic phosphorous component. The acidic phosphorous component may be configured to change in oxidation state when the resin contacts a heat transfer fluid. The component may be an acidic or basic nitrogenous component. The acidic or basic nitrogenous component may be configured to change in oxidation state when the resin contacts a heat transfer fluid. The component may be an acidic sulfurous component. The acidic sulfurous component may be configured to change in oxidation state when the resin contacts a heat transfer fluid. The component may be a mixture of two or more of an acidic phosphorous component, an acidic or basic nitrogenous component, and an acidic sulfurous component.

The pre-treated ion exchange resin may be present in a set of beads. The set of beads may include resin that is not pre-treated. The pre-treated ion exchange resin may be present in a first set of beads. The first set of beads may be present in a mixture. The mixture may include the first set of beads and a second set of beads. The second set of beads may not include the pre-treated ion exchange resin.

The pre-treated ion exchange resin may include a heat transfer fluid. The heat transfer fluid may include water. The heat transfer fluid may include a glycol-based freeze-point depressant. The heat transfer fluid may include a mixture of water and a glycol-based freeze-point depressant. The glycol-based freeze-point depressant may be ethylene glycol. The glycol-based freeze-point depressant may be propylene glycol. The glycol-based freeze-point depressant may be 1,3-propanediol. The glycol-based freeze-point depressant may be a mixture of two or more of: ethylene glycol, propylene glycol, and 1,3-propanediol.

The pre-treated ion exchange resin may be a basic anion exchange resin. The pre-treated ion exchange resin may be an acidic cation exchange resin. The pre-treated ion exchange resin may be a mixture of a basic anion exchange resin and an acidic cation exchange resin.

The pre-treated ion exchange resin may be present in a vessel. The vessel may be configured to receive from a closed liquid heat transfer circuit the heat transfer fluid. The vessel may be configured to provide to a closed liquid heat transfer circuit the heat transfer fluid. The vessel may be configured to receive from, and provide to, a closed liquid heat transfer circuit the heat transfer fluid.

The pre-treated ion exchange resin may include ion-exchangeable groups. The ion-exchangeable groups may include one or more ions. The ion-exchangeable groups may include one or more Bronsted acids. The ion-exchangeable groups may include one or more Bronsted bases. The ion-exchangeable groups may be selected from: an ion, a Bronsted acid, and a Bronsted base. At least one of the ion exchangeable groups may have reducing properties.

The pre-treated ion exchange resin may result from reaction with an aqueous solution. The aqueous solution may have a pKa of 0 to 14. The aqueous solution may have a pKa from 2 to 12.

The aqueous solution may include a treatment corrosion inhibitor. The treatment corrosion inhibitor may include a phosphorous component. The phosphorous component may be a phosphorous acid and/or salt thereof. The phosphorous component may be a hypophosphorous acid and/or salt thereof. The phosphorous component may be an organophosphorus compound and/or salt thereof. The phosphorous component may be a phosphonic acid ester and/or salt thereof. The phosphorous component may be a mixture of two or more of a phosphorous acid and/or salt thereof, a hypophosphorous acid and/or salt thereof, an organophosphorus compound and/or salt thereof, and a phosphonic acid ester and/or salt thereof. The phosphorous component may include an H—PO(OH)ₙ(OR)ₘ structure. R may be selected from an alkyl, a hydroxyalkyl, and an aryl-group. n and m may be, independently, 0-2. n+m may be 2.

The pre-treated ion exchange resin may include an SBA ion exchange resin. The SBA ion exchange resin may include a phosphite ion-exchangeable group HPO₃²⁻. The phosphite ion-exchangeable group may be temperature stable up to 100° C. when the pre-treated ion exchange resin contacts a coolant.

The aqueous solution may include a treatment corrosion inhibitor. The treatment corrosion inhibitor may include a nitrogenous component. The nitrogenous component may be a hydrazine derivative of general formula H₂N—NH₂. The nitrogenous component may be a carbohydrazide derivative of general formula (H₂N—NH)C—O═(HN—NH₂). The nitrogenous component may be a mixture of a hydrazine derivative of general formula H₂N—NH₂ and a carbohydrazide derivative of general formula (H₂N—NH)C—O═(HN—NH₂).

The treatment corrosion inhibitor may include a sulfurous component. The sulfurous component may be a sulfurous acid and/or salt thereof. The sulfurous component may be a sulfite and/or salt thereof. The sulfurous component may be a bisulfite and/or salt thereof. The sulfurous component may be a metabisulfite and/or salt thereof. The sulfurous component may be a mixture of two or more of a sulfurous acid and/or salt thereof, a sulfite and/or salt thereof, a bisulfite and/or salt thereof, and a metabisulfite and/or salt thereof.

The heat transfer fluid may include a RedOx catalyst. The RedOx catalyst may be an anthraquinone derivative. The RedOx catalyst may be a benzoquinone derivative. The RedOx catalyst may be catechol. The RedOx catalyst may be pyrogallol. The RedOx catalyst may be a mixture of two or more of an anthraquinone derivative, a benzoquinone derivative, catechol, and catechol.

The pre-treated ion exchange resin may include an SBA Type II ion exchange resin in hydroxide-form. The heat transfer fluid may include a triazole-based corrosion inhibitor. The heat transfer fluid may include an organic silicate derivative. The heat transfer fluid may include a triazole-based corrosion inhibitor and an organic silicate derivative.

The heat transfer fluid may have a conductivity of less than about 200 μS/cm. The heat transfer fluid may have a conductivity from about 0.5 to about 10 μS/cm.

The aqueous solution may include a fluid corrosion inhibitor. The fluid corrosion inhibitor may be reversibly bound to the pre-treated ion exchange resin.

The pre-treated ion exchange resin may be present in a resin compound. 15% or more of the compound may be pre-treated ion exchange resin. 25% or more of the compound may be pre-treated ion exchange resin.

The heat transfer fluid may not include corrosion-inhibiting components. The heat transfer fluid may be a low conductivity heat transfer fluid.

A method of making a pre-treated ion exchange resin is provided. The method may include contacting the ion exchange resin with an aqueous treatment solution. The aqueous treatment solution may contain a corrosion inhibitor. The method may include contacting the ion exchange resin with an aqueous treatment solution containing a corrosion inhibitor until an absorption rate of the corrosion inhibitor by the ion exchange resin decreases to approximately zero.

In some embodiments, the treatment inhibitor may include a sulfite, bisulfite, metabisulfite, or a mixture thereof. 3,3′-thiodipropionic acid, 2,2′-thiodiglycolic acid and thioglycolic acid salts are also suited as they have reducing properties and may bind to an anion exchange resin through ionic interactions. The sulfur-containing reagents bound to the resin may function as antioxidant/reducing agents and may slow down glycol degradation. Bisulfites are also known to undergo addition reactions with aldehydes or ketones to so-called hydrogen sulfite adducts, wherein the sulfur of the hydrogen sulfite ion attaches to the carbonyl group to form a hydroxyalkyl sulfone. In addition to sulfite's reducing properties, this reaction mechanism may trap aldehydes and prevent them from further oxidation to acids, which may cause an increase in conductivity and corrosion. Sulfite and sulfate ions produced in situ from the oxidation process are corrosive when released from the resin. Phosphorous compounds may therefore be preferred over inorganic sulfur reagents, due to their anti-corrosive properties.

In some embodiments, the treatment inhibitor may include an azole compound. Suitable azole compounds may be five-membered heterocyclic compounds having 1 to 4 nitrogen atoms. Illustrative examples may include imidazoles, triazoles, thiazoles and tetrazoles, such as benzotriazole, tolyltriazole, alkyl benzotriazoles, such as 4-methyl benzotriazole, 5-methyl benzotriazole, and butyl benzotriazole and the like, benzoimidazole, halobenzotriazols, such as chloro-methylbenzotriazole, tetrazole, substituted tetrazoles, thiazoles, such as 2-mercaptobenzothiazole, and the like. In some embodiments, the azole compound may be benzotriazole, tolyltriazole, mercaptobenzothiazole, or mixtures thereof. Azole compounds do not have reducing properties. Nevertheless, due to their weak resin binding properties a triazole-treated resin may be used instead of an untreated anionic and/or mixed bed resin. Benzotriazoles show weak basic properties, therefore, they may bind to SAC ion exchange resin. Nevertheless, benzotriazole's acidic properties are more pronounced, and therefore, benzotriazole may bind more strongly to SBA ion exchange resins. When a benzotriazole pre-treated mixed-bed resin is exposed to corrosive water containing sodium salts of chloride, sulfate and carbonate, the aqueous solution may be de-ionized and benzotriazole may be released into the solution affording a pH neutral solution. When benzotriazole pre-treated SAC ion exchange resin is exposed to corrosive water, the cations present may release benzotriazole and may cause a pH decrease affording a corrosive environment. A pH increase may occur with a benzotriazole-treated SBA ion exchange resin.

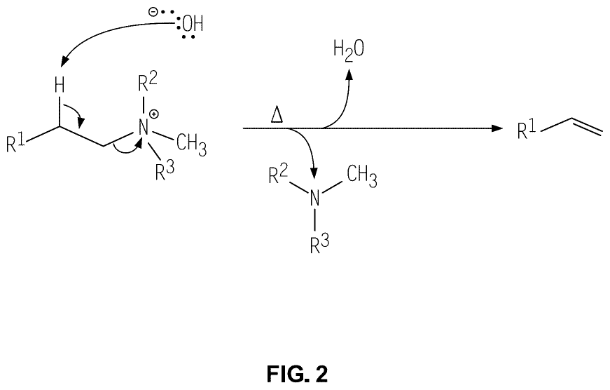

SBA exchange resin may be used in its hydroxide-form in low conductivity coolant applications. Quaternary ammonium salts are prone to Hofmann Elimination when hydroxide counterions are present. Hydroxide's strong basic properties are responsible for the elimination rection. The elimination reaction is catalyzed by heat and affords ammonia and an alkene (see FIG. 2). Hofmann-Amine degradation was an important means of elucidating the structure of nitrogenous natural products (alkaloids) in the past. In anesthesiology, Hofmann Elimination is significant in relation to the inactivation of certain muscle relaxants after surgery.

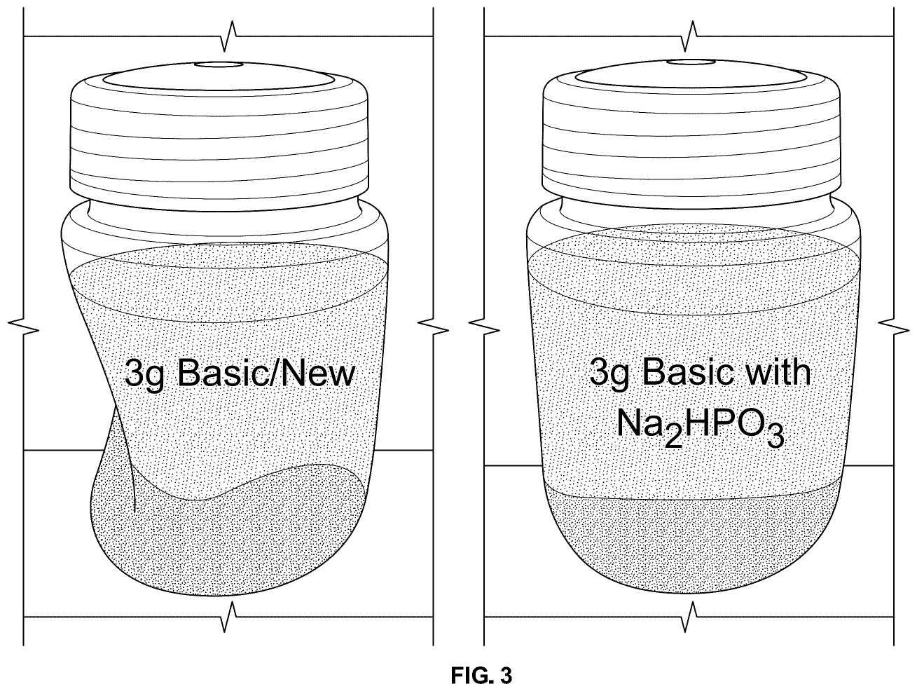

As the quaternary ammonium function on the resin is lost, the strong basic anion exchange resin loses its functionality to bind ionic substances. The resin may also darken and generate an ammonia smell. Ammonia can also increase the pH and cause other deteriorating side effects in the heat transfer system. When replacing the hydroxide with a less basic anion, like a phosphite anion as described above, the Hofmann Elimination may be impeded, and the strong basic anion resin can be exposed to a higher temperature during operating conditions. An advantage of replacing hydroxide with a phosphite anion may be illustrated by the unchanged color of the pre-treated resin. There was also no ammonia smell observed after storage at 90° C. in de-ionized water, compared to the original strong basic anion exchange resin. The untreated strong basic anion exchange resin changed color from yellow to dark brown (see FIG. 3 and Table 2, 3 g Basic NEW). This effect is not only illustrated in solution. While “dry” SBA resin in its OH-form stored at 50° C. in a container quickly generates a strong smell of ammonia, strong basic anion resin in its phosphite-form and benzotriazole-treated resin generates no ammonia smell (see FIG. 3 and Table 2, 3 g Basic with Na₂HPO₃).

TABLE 2

| | | | Conductivity | | RA | | | | | |
|---|---|---|---|---|---|---|---|---|---|---|
| | pH | | (μS/cm) | | mL, | Si | BTZ | TTZ | PO₄⁻³ | |
| RESIN | before | after | before | after | pH 7 | mg/L | mg/L | mg/L | mg/L | NOTES |
| 3 g Basic | 9.00 | 10.8 | 3.630 | 146.4 | 0.7 | 0 | 0 | 0 | 0 | Gas bubbles. |
| NEW | | | | | | | | | | Strong smell of |
| | | | | | | | | | | ammonia. Resin |
| | | | | | | | | | | darkened. |
| 3 g Basic | 5.72 | 6.83 | 1.570 | 41.91 | 0 | 0 | 0 | 0 | 21 | No smell. No color |
| with | | | | | | | | | | change. |
| Na₂HPO₃ | | | | | | | | | | |

For testing corrosion protection, pre-screening evaluation carbon steel ASTM coupons were submerged in 100 ml ASTM 1384 corrosive water (“CW”) and 3 g of a pre-treated ion exchange resin was added. Corrosive water contains 148 ppm sodium sulfate, 165 ppm sodium chloride, and 138 ppm bicarbonate: 100 ppm each corrosive anion. The coupons were stored in 33% glycol solution at 55° C. for 3 days. The coupons and solution appearance were evaluated visually (see FIGS. 3-5) and by ion chromatography (“IC”). De-ionized water and De-ionized water over 3 g mixed-bed resin were included as reference. A hydrogen phosphate pre-treated resin was also included in the screening. The table below (Table 3) shows that pre-treated resins can protect regular carbon steel under corrosive conditions. Chloride from the corrosive water is not nucleophilic enough to replace phosphite from a pre-treated resin. Sodium, on the other hand, can replace a hydrazine derivative from a strong acidic cation resin. When phosphite pre-treated resin is used in combination with corrosive water it is therefore recommended to use a combination of pre-treated resin with untreated resin, or a combination with a triazole pre-treated resin. When Carbohydrazide pre-treated resin was used, some coupons had a “blued steel” appearance. Steel corrosion is sensitive to pH. Phosphite, HPO₃²⁻, pre-treated resin produced the optimal results. Carbon steel was chosen due to its tendency to corrode. Low conductivity cooling systems may use stainless steel, aluminum, and copper, which are less likely to corrode.

TABLE 3

| | | | | | | | | Conductivity | |
|---|---|---|---|---|---|---|---|---|---|
| | | Resin | | | Chloride | Sulfate | Phosphate | after Test | Coupon |
| Sample # | | g | Solvent | pH | mg/L | mg/L | mg/L | μs/cm | Appearance |
| Ref | DIW | 3 | DIW | 5.92 | n.a. | n.a. | n.a. | 3.5 | corroded |
| Ref | DI-Water over Mixed-bed Resin | 3 | DIW | 6.65 | n.a. | n.a. | n.a. | 0.5 | corroded |
| 1 | TTZ (SBA) | 3 | CW | 11.05 | 2.6 | 0.8 | n.a. | 330 | metallic |
| 2 | H₃PO₃ (SBA) | 3 | CW | 7.56 | 12.3 | 1.6 | 164.2 | 190 | corroded |
| 3 | H₃PO₃ (SBA) - No Cl | 3 | CW | 7.33 | n.a. | 0 | 135 | 150 | grey deposit |
| 4 | H₃PO₄ (SBA) | 3 | CW | 8.27 | 14 | 4 | 169 | 216 | grey deposit |
| 5 | Carbohydrazide (Mixed) | 3 | CW | 7.59 | 6 | 9 | n.a | 80 | metallic |
| 6 | Carbohydrazide; cat. (Mixed) | 3 | CW | 7.17 | 8 | 18 | n.a | 57 | metallic |
| 7 | TTX Mixed/H₃PO₃ (SBA) ⁺ | 3 | CW | 5.19 | 0 | 0 | n.a. | 3.616 | metallic |
| 8 | TTX Mixed/Carbohydrazide Mixed ⁺ | 3 | CW | 4.82 | 0 | 0 | n.a. | 8.493 | metallic |
| 9 | TTX Basic/Carbohydrazide (SAC) ⁺ | 3 | CW | 8.6 | 0 | 0 | n.a. | 3.436 | metallic |

⁺ 3 mg sodium anthraquinone-2-sulfonate

The disclosed pre-treated ion exchange resins are advantageous in that they can remove ionic species from a heat transfer fluid, maintaining low conductivity. The compositions may include a pre-treated ion exchange resin that sustains a low electrical conductivity of the coolant composition. Because the anti-corrosive and de-oxidizing exchangeable ions suppress oxidation of the heat transfer fluid and block ions from eluting into a cooling system preventing an increase in conductivity of the coolant composition, the pre-treated ion exchange resin sustains a low conductivity of the coolant composition over a long period of time. The pre-treated ion exchange resin therefore allows the use of uninhibited heat transfer fluids in alternative power source heat transfer systems while keeping a low electrical conductivity of the heat transfer fluid.

In some embodiments, the disclosed pre-treated ion exchange resins may be used in a cooling system, especially a fuel cell or BEV cooling system. Illustrative types of suitable fuel cells may include PEM fuel cells. However, it will be appreciated that the disclosed pre-treated ion exchange resins and heat transfer fluids passing through such resins to maintain low conductivity may be used in applications other than fuel cells or BEVs that require a heat transfer fluid. Suitable applications include cooling systems that require heat transfer fluids with low conductivity.

### Example 1

A modified ASTM 1384 was used to evaluate the performance of treated resin compared to a standard ASTM corrosive water solution in 33% glycol: metal test coupons (carbon steel, aluminum, copper, and brass) were prepared according to ASTM 1384, both yellow metal coupons were non-conductively connected with carbon steel and aluminum by means of plastic bolts with nuts and Teflon washers and placed on two Teflon stands in a 1 L beaker having a ground glass joint and glass cover. Copper, brass, carbon steel, and aluminum were each conductively connected. 750 ml of ASTM corrosive water test liquid was then introduced. The ASTM corrosive water test solution has an initial electrical conductivity of 260 μS/cm. A filter bag with 11.0 g pre-treated resin was placed into the solution and the solution was heated to 45° C. for 14 days with an aeration rate of 100+/−10 mL/min. pH, conductivity, and metal loss/visual inspection were evaluated before and after the test. ASTM D8485-23 “Corrosion Test for Electric Vehicle Coolants in Glassware” was also employed but did not afford any distinguishable results due to less severe conditions: stainless steel, aluminum, and transfer fluids having low conductivity.

A means for maintaining the desired purity of the heat transfer fluid is to incorporate an ion exchange resin in a circulation loop defining a flow path for a heat transfer fluid and an ion exchange resin in a filter cartridge, positioned in the flow path so that the heat transfer fluid must flow through the ion exchange resin. The ion exchange filter cartridge should be positioned at the point of the lowest temperature in the circulation loop and be easily accessible for replacement when needed. The filter cartridge may be composed of a filter casing containing the ion exchange resin beads. For efficient ion removal, a mixed-bed filter may be employed. Separation of anion exchange resin and cation exchange resin in separate filter cartridges may allow for easier resin regeneration if recycling is advantageous.

The bead size and size distribution, e.g., monodisperse vs. heterodisperse, determine the pressure loss, pump dimension requirement, and ion exchange capability. The ion exchange resin amount, and therefore, filter size may be determined by the heat transfer fluid volume, initial circulation loop contamination and initial ion concentration of the water used for circulation loop system filling. As glycol degradation is more severe at higher temperatures and during frequent warm/cold cycles, the filter size, particularly the required resin capacity, may be determined by operating conditions.

The circulation loop may be in thermal communication with any arrangement that allows heat produced by an exothermic reaction. Such arrangements can include fuel cells, battery systems, electric converters, electric inverters, electric generators, power electronics, and electrical devices. Different arrangements and systems have different electrical conductivity requirements and may require different ion exchange resin combinations and filter sizes.

The results in the table below (Table 4) and FIGS. 3-7 show that ionic species were removed from the corrosive water solution and pre-treated ion exchange resins were able to protect metals even under galvanic conditions. When triazole pre-treated resin was employed, triazoles were detected in the heat transfer solution after the tests. The test solutions were clear after the tests.

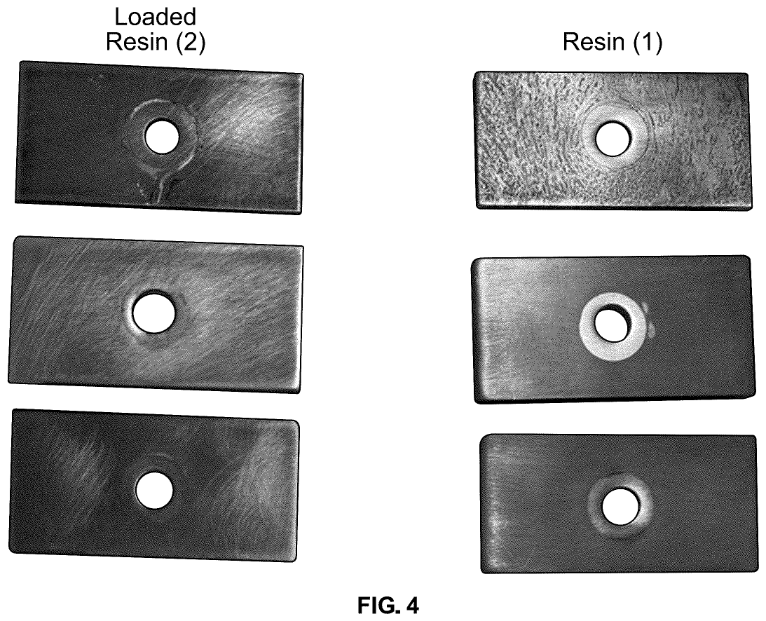

FIG. 4 shows photographs of three metal coupons treated with Resin (1), i.e., an untreated ion exchange resin, on the right-hand side, and three metal coupons treated with Loaded Resin (2), i.e., a pre-treated ion exchange resin, on the left-hand side.

Table 4 shows results corresponding to metal coupons treated with Resin (1) and metal coupons treated with Loaded Resin (2).

TABLE 4

| | Cond. | Cond. | pH | pH | Steel | | | Fe (after) | | Cu (after) | |
|---|---|---|---|---|---|---|---|---|---|---|---|
| | (before) | (after) | (before) | (after) | (loss) | Al (loss) | Cu (loss) | Glycolate | | Formiate | |
| Resin | 1.57 | 8.90 | 5.61 | 4.3 | min. 196 | 1 | 17 | 1.5 | ppm | 0.9 | ppm |
| (1) | μS/cm | μS/cm | | | mg/coupon | mg/coupon | mg/coupon | 15 | ppm | 2.5 | ppm |
| Loaded | 1.57 | 9.20 | 5.61 | 4.2 | 49 | 2 | 0.5 | 3.0 | ppm | 0.01 | ppm |
| Resin | μS/cm | μS/cm | | | mg/coupon | mg/coupon | mg/coupon | 12.5 | ppm | 3.6 | ppm |
| (2) | | | | | | | | | | | |

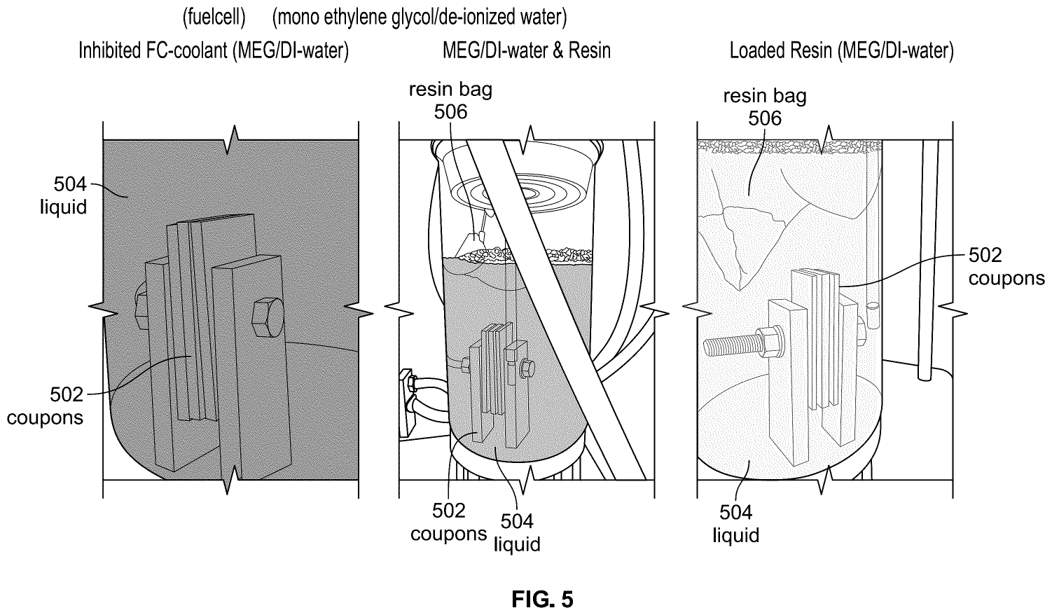

FIG. 5 shows: (a) metal coupons 502 treated with an inhibited fuel cell (“FC”)-coolant in mono-ethylene glycol (“MEG”) and de-ionized water (“DI-water”) liquid 504 (darkest) on the left-hand side; (b) metal coupons 502 treated with Resin (i.e. an untreated ion exchange resin) in a resin bag 506 in MEG/DI-water liquid 504 (medium darkness) in the middle; and (c) and metal coupons 502 treated with a Loaded Resin (i.e., a pre-treated ion exchange resin) in a resin bag 506 in MEG/DI-water liquid 504 (lightest/clearest) on the right-hand side.

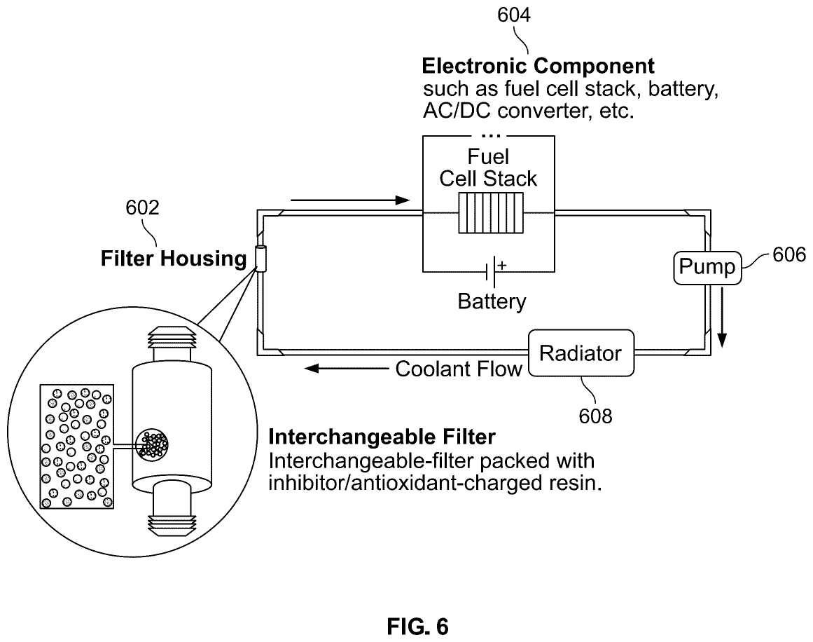

FIG. 6 illustrates an exemplary ion exchange resin unit. An ion exchange resin unit may contain an electronic component 604. The electronic component 604, e.g., a fuel cell stack, battery, and AC/DC converter, may provide electric power to the ion exchange resin unit. The ion exchange resin unit may contain a pump 606. The ion exchange resin unit may contain a radiator 608. The ion exchange resin unit may contain an interchangeable filter 602. The interchangeable filter 602 may be packed with an inhibitor/antioxidant ion exchange resin. The electronic component 604 may power the pump 606. The pump 606 may push coolant through the radiator 608. The coolant may flow through a filter housing. The filter housing may contain the interchangeable filter 602. The coolant may flow in a closed loop.

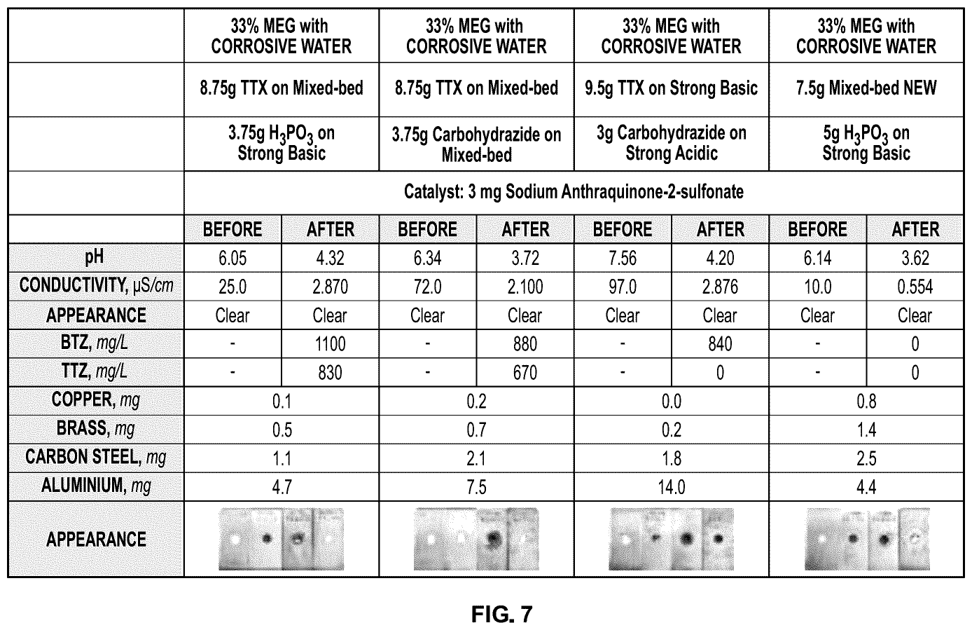

FIG. 7 shows a table containing results that are in accordance with principles of the disclosure.

Some embodiments may omit features shown or described in connection with the illustrative apparatus. Some embodiments may include features that are neither shown nor described in connection with the illustrative apparatus. Features of illustrative apparatus may be combined. For example, one illustrative embodiment may include features shown in connection with another illustrative embodiment.

Embodiments may involve some or all of the features of the illustrative apparatus or some or all of the steps of the illustrative methods.

The illustrative apparatus and methods will now be described with reference to the accompanying Figures, which form a part hereof. It is to be understood that other embodiments may be utilized, and that structural, functional, and procedural modifications may be made without departing from the scope and spirit of the present disclosure.

FIG. 1 shows exemplary chemical structures in accordance with the principles of the disclosure.

FIG. 2 shows an exemplary chemical reaction in accordance with the principles of the disclosure.

FIG. 3 shows a photograph of a comparison of substances treated with and without an ion exchange resin in accordance with the principles of the disclosure.

FIG. 4 shows a photograph of coupons of metal used in accordance with the principles of the disclosure.

FIG. 5 shows a photograph of a comparison of substances treated with and without an ion exchange resin used in accordance with the principles of the disclosure.

FIG. 6 shows an illustrative schematic diagram in accordance with the principles of the disclosure.

FIG. 7 shows an illustrative table containing results in accordance with the principles of the disclosure.

As will be appreciated by one of skill in the art, methods and apparatus shown or described herein may be embodied in whole or in part as a method, an apparatus, or product by process.

All ranges and parameters disclosed herein shall be understood to encompass any and all subranges subsumed therein, every number between the endpoints, and the endpoints. For example, a stated range of “1 to 10” should be considered to include any and all subranges between (and inclusive of) the minimum value of 1 and the maximum value of 10; that is, all subranges beginning with a minimum value of 1 or more (e.g., 1 to 6.1), and ending with a maximum value of 10 or less (e.g., 2.3 to 9.4, 3 to 8, 4 to 7), and finally to each number 1, 2, 3, 4, 5, 6, 7, 8, 9, and 10 contained within the range.

Thus, apparatus and methods for pre-treated ion exchange resins and their use in heat transfer systems, alternative power sources such as fuel cells, battery systems, and assemblies comprising such power sources are provided. Persons skilled in the art will appreciate that the present invention can be practiced by other than the described embodiments, which are presented for purposes of illustration rather than of limitation, and that the present invention is limited only by the claims that follow.

What is claimed is:

1. A pre-treated ion exchange resin for inhibiting corrosion comprising a component selected from the group consisting of:
(a) an acidic phosphorous component that is configured to undergo a change in oxidation state when the resin contacts a heat transfer fluid;
(b) an acidic or basic nitrogenous component that is configured to undergo a change in oxidation state when the resin contacts the heat transfer fluid;
(c) an acidic sulfurous component that is configured to undergo a change in oxidation state when the resin contacts the heat transfer fluid; and
(d) a mixture of two or more of (a)-(c).

2. The pre-treated ion exchange resin of claim 1 wherein the ion exchange resin is present in a set of beads.

3. The pre-treated ion exchange resin of claim 2 wherein the beads include resin that is not pre-treated.

4. The pre-treated ion exchange resin of claim 1 wherein:
the pre-treated ion exchange resin is present in a first set of beads;
the first set of beads is present in a mixture that includes:
the first set of beads; and
a second set of beads; and
the second set of beads does not include the pre-treated ion exchange resin.

5. The pre-treated ion exchange resin of claim 1 wherein:
the heat transfer fluid includes a mixture of water and a glycol-based freeze-point depressant; and
the glycol-based freeze-point depressant is selected from the group consisting of:
(a) ethylene glycol;
(b) propylene glycol;
(c) 1,3-propanediol; and
(d) a mixture of two or more of (a)-(c).

6. The pre-treated ion exchange resin of claim 1 wherein the pre-treated ion exchange resin is selected from the group consisting of:
a basic anion exchange resin;
an acidic cation exchange resin; and
a mixture of a basic anion exchange resin and an acidic cation exchange resin.

7. The pre-treated ion exchange resin of claim 1 wherein the pre-treated ion exchange resin is present in a vessel configured to receive from, and provide to, a closed liquid heat transfer circuit the heat transfer fluid.

8. The pre-treated ion exchange resin of claim 1 wherein:
the pre-treated ion exchange resin includes ion-exchangeable groups;
the ion-exchangeable groups are selected from:
an ion;
a Bronsted acid; and
a Bronsted base; and
at least one of the ion exchangeable groups has reducing properties.

9. The pre-treated ion exchange resin of claim 8 wherein the pre-treated ion exchange resin results from reaction with an aqueous solution having a pKa of 0 to 14.

10. The pre-treated ion exchange resin of claim 9 wherein the aqueous solution has a pKa from 2 to 12.

11. The pre-treated ion exchange resin of claim 9 wherein:
the aqueous solution comprises a treatment corrosion inhibitor;
the treatment corrosion inhibitor includes a phosphorous component; and
the phosphorous component is selected from the group consisting of:
(a) phosphorous acid and/or salt thereof;
(b) hypophosphorous acid and/or salt thereof;
(c) an organophosphorus compound and/or salt thereof;
(d) a phosphonic acid ester and/or salt thereof; and
(e) a mixture of two or more of (a)-(d);
the phosphorous component includes an H—PO(OH)ₙ(OR)ₘ structure; and
R is selected from an alkyl, a hydroxyalkyl, and an aryl-group;
n and m are 0-2; and
n+m is 2.

12. The pre-treated ion exchange resin of claim 9 wherein:
the pre-treated ion exchange resin includes a strong basic anion (“SBA”) ion exchange resin;
the SBA ion exchange resin includes phosphite ion-exchangeable group HPO₃²⁻; and
the phosphite ion-exchangeable group is temperature stable up to 100° C. when the pre-treated ion exchange resin contacts a coolant.

13. The pre-treated ion exchange resin of claim 9 wherein:
the aqueous solution comprises a treatment corrosion inhibitor;
the treatment corrosion inhibitor comprises a nitrogenous component; and
the nitrogenous component is selected from the group consisting of:
(a) a hydrazine derivative of general formula H₂N—NH₂;
(b) a carbohydrazide derivative of general formula
(H₂N—NH)C═O(HN—NH₂); and
(c) a mixture of (a) and (b).

14. The pre-treated ion exchange resin of claim 9 wherein:
the aqueous solution comprises a treatment corrosion inhibitor;
the treatment corrosion inhibitor includes a sulfurous component; and
the sulfurous component is selected from the group consisting of:
(a) sulfurous acid and/or salt thereof;
(b) a sulfite and/or salt thereof;
(c) a bisulfite and/or salt thereof;
(d) a metabisulfite and/or salt thereof; and
(e) a mixture of two or more of (a)-(d).

15. The pre-treated ion exchange resin of claim 1 wherein:
the heat transfer fluid includes a reduction/oxidation (“RedOx”) catalyst;
and the RedOx catalyst is selected from the group consisting of:
(a) an anthraquinone derivative;
(b) a benzoquinone derivative;
(c) catechol;
(d) pyrogallol; and
(e) a mixture of two or more of (a)-(d).

16. The pre-treated ion exchange resin of claim 1 comprising a strong basic anion (“SBA”) Type II ion exchange resin in hydroxide-form.

17. The pre-treated ion exchange resin of claim 1 wherein in the heat transfer fluid includes:
a triazole-based corrosion inhibitor; and
an organic silicate derivative.

18. The pre-treated ion exchange resin of claim 1 wherein the heat transfer fluid has a conductivity of less than about 200 μS/cm.

19. The pre-treated ion exchange resin of claim 1 wherein the heat transfer fluid has a conductivity from about 0.5 to about 10 μS/cm.

20. The pre-treated ion exchange resin of claim 9 wherein the aqueous solution includes a fluid corrosion inhibitor that is reversibly bound to the pre-treated ion exchange resin.

21. The pre-treated ion exchange resin of claim 1 wherein:
the pre-treated ion exchange resin is present in a resin compound; and
15% or more of the compound is pre-treated ion exchange resin.

22. The pre-treated ion exchange resin of claim 1 wherein:
the pre-treated ion exchange resin is present in a resin compound; and
25% or more of the compound is pre-treated ion exchange resin.

23. The pre-treated ion exchange resin of claim 1 wherein the heat transfer fluid does not include corrosion-inhibiting components.

24. The pre-treated ion exchange resin of claim 1 wherein the heat transfer fluid is a low conductivity heat transfer fluid.

25. A method of making a pre-treated ion exchange resin, the method comprising contacting the ion exchange resin with an aqueous treatment solution containing a corrosion inhibitor until an absorption rate of the corrosion inhibitor by the ion exchange resin decreases to approximately zero.
